(19) United States
(12) Patent Application Publication
(10) Pub. No.: US 2008/0316110 A1
(43) Pub. Date: Dec. 25, 2008

(54) Patch Antenna and RFID Inlet

(75) Inventors: Tomohiko KANEMURA, Kyoto-shi (JP); Takeshi Fujiwara, Kyoto-shi (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: SUNCALL CORPORATION, Kyoto-shi (JP)

(21) Appl. No.: 12/142,633

(22) Filed: Jun. 19, 2008

(30) Foreign Application Priority Data
Jun. 22, 2007 (JP) 2007-165454

(51) Int. Cl. H01Q 9/04

(52) U.S. Cl. 343/700 MS

(57) ABSTRACT

The present invention provides a patch antenna including a dielectric member, and a conductive first radiation element and a conductive ground electrode respectively provided on one and the other surfaces of the dielectric member, the patch antenna further including a conductive second radiation element which has a length different from that of the first radiation element in the direction of resonance, the second radiation element being provided on the one surface of the dielectric member in a state of being insulated from the first radiation element with respect to the direct electric current while being electromagnetically coupled to the first radiation element.

### BACKGROUND OF THE INVENTION

1. Field of the Invention

The present invention relates to a patch antenna, and an RFID inlet including the patch antenna and a transmission/reception element.

2. Background Art

An RFID inlet having a patch antenna and a transmission/reception element has been utilized in various types of fields such as physical distribution management and human entry/exit management, since the RFID inlet is capable of transmitting and receiving identification information with high accuracy and high efficiency. On the other hand, the RFID inlet has an extremely high sensitivity with respect to a signal frequency, which has induced the problem that a frequency band of the signal that the RFID inlet is capable of transmitting and/or receiving is significantly narrow.

For example, in Japan, U.S. and Europe, the frequency bands of 952 to 954 MHz, 902 to 928 MHz and 865 to 868 MHz are utilized respectively for physical distribution management. However, there have existed no RFID patch antenna inlets capable of covering these frequency bands.

For example, Japanese unexamined patent publication No. 2002-299948 (hereinafter, referred to as Patent Document 1) proposes a patch antenna including a dielectric member, a plurality of radiation conductors with different shapes to one another which are provided on one surface of the dielectric member, a ground conductor provided on the other surface of the dielectric member and a single power feed portion, wherein the single power feed portion is electrically connected to the plurality of radiation conductors.

The patch antenna described in the Patent Document 1 is configured so that the frequency bands of the signals which the plurality of radiation conductors are capable of transmitting and receiving are different by making the plurality of radiation conductors different shapes one another. However, the patch antenna is needed to provide respective power feed structures for the plurality of radiation conductors, resulting in complicated structure.

Further, Japanese unexamined patent publication No. 2004-208224 (hereinafter, referred to as Patent Document 2) proposes a patch antenna with a patch electrode having an extending portion sandwiched between a pair of cutouts.

The patch antenna described in the Patent Document 2 is capable of transmitting and receiving first and second high-frequency signals, wherein the first high-frequency signal causes a band-shaped area extending from the tip end until the other end of the extending portion to resonate, and the second high-frequency signal has a frequency higher than the first high-frequency signal and causes other area excluding the band-shaped area to resonate.

However, the patch antenna described in the Patent Document 2 is configured so that the extending portion and the other area are coupled to each other at their end portions in the direction of resonance through a conductive member (namely, an electric current flows between the extending portion and the other area), resulting in a significantly large frequency ratio of the first and second high-frequency signals.

Accordingly, it is impossible to utilize the patch antenna described in Patent Document 2 in a plurality of frequency bands arranged so that a frequency ratio among them is close to 1, such as a plurality of frequency bands including the first frequency band of 952 to 954 MHz, the second frequency band of 902 to 928 MHz and the third frequency band of 865 to 868 MHz.

Further, the Patent Document 2 does not give any description about transmission and reception of signals in three different frequency bands.

### BRIEF SUMMARY OF THE INVENTION

In view of such a conventional art, it is the first objective of the present invention to provide a patch antenna and an RFID inlet capable of transmitting and receiving signals at two frequency bands arranged so that a frequency ratio is close to 1.

Further, it is the second objective of the present invention to provide a patch antenna and an RFID inlet capable of transmitting and receiving signals at three frequency bands arranged so that frequency ratios are close to 1.

The present invention provides, in order to achieve the first objective, a patch antenna including a dielectric member, and a conductive first radiation element and a conductive ground electrode respectively provided on one and the other surfaces of the dielectric member, the patch antenna further including a conductive second radiation element which has a length different from that of the first radiation element in the direction of resonance, the second radiation element being provided on the one surface of the dielectric member in a state of being insulated from the first radiation element with respect to the direct electric current while being electromagnetically coupled to the first radiation element.

The patch antenna according to the present invention makes it possible to transmit and receive signals at two frequency bands arranged so that a frequency ratio therebetween is close to 1, since the second radiation element which has a length different from that of the first radiation element in the direction of resonance is positioned so as to be insulated from the first radiation element with respect to the direct electric current while being electromagnetically coupled to the first radiation element.

The first radiation element may have the first side edge extending in the direction of resonance. In the configuration, the second radiation element ma have a side edge which is opposed to the first side edge of the first radiation element in a state of being substantially parallel to the first side edge.

More preferably, the second radiation element is positioned so as to be opposed to the first side edge over at least ½ of the length of the first side edge.

The present invention provides, in order to achieve the second objective, a patch antenna further including a conductive third radiation element which has a length different from those of the first and second radiation elements in the direction of resonance, the third radiation element being provided on the one surface of the dielectric member in a state of being insulated from the first radiation element with respect to the direct electric current while being electromagnetically coupled to the first radiation element, in addition to the components in the above various configurations.

The thus configured patch antenna makes it possible to transmit and receive signals at three frequency bands arranged so that frequency ratios thereamong are close to 1, since the third radiation element which has a length different from those of the first and second radiation elements in the direction of resonance is positioned so as to be insulated from the first radiation element with respect to the direct electric current while being electromagnetically coupled to the first radiation element.

In the first embodiment, the third radiation element is positioned so as to be opposed to the first radiation element on a side of the first radiation element opposite to the second radiation element with the first radiation element being sandwiched between the second and third radiation elements.

In a case where the first radiation element has the second side edge extending in the direction of resonance on a side opposite to the first side edge in the first embodiment, the third radiation element preferably has a side edge which is opposed to the second side edge of the first radiation element in a state of being substantially parallel to the second side edge.

More preferably, the third radiation element is positioned so as to be opposed to the second side edge over at least ½ of the length of the second side edge.

In the second embodiment, the third radiation element is positioned so as to be opposed to the first radiation element in a state that the second radiation element is sandwiched by the first and third radiation elements.

In the second embodiment, the third radiation element preferably has a side edge which is opposed to the first side edge of the first radiation element in a state of being substantially parallel to the first side edge.

More preferably, the third radiation element is positioned so as to be opposed to the first side edge over at least ½ of the length of the first side edge.

Furthermore, the present invention provides, in order to achieve the first objective, a patch antenna including a dielectric member, and a conductive first radiation element and a conductive ground electrode respectively provided on one and the other surfaces of the dielectric member, the patch antenna further including a conductive second radiation element which has a length different from that of the first radiation element in the direction of resonance and which is provided on the one surface of the dielectric member, wherein the second radiation element is configured so that only its center portion in the direction of resonance is connected to the center portion of the first radiation element in the direction of resonance through a conductive member having a width smaller than the signal wavelength and the other portion of the second radiation element is positioned away from the first radiation element within a range of being electromagnetically coupled to the first radiation element.

The thus configured patch antenna makes it possible to transmit and receive signals at two frequency bands arranged so that a frequency ratio therebetween is close to 1.

Furthermore, the present invention provides an RFID inlet including the patch antenna according to the above various configurations, and a transmission/reception element transmitting and receiving signals through the patch antenna.

### BRIEF DESCRIPTION OF THE DRAWINGS/FIGURES

The above, and other objects, features and advantages of the present invention will become apparent from the detailed description thereof in conjunction with the accompanying drawings wherein.

FIG. 1 is a perspective view of a patch antenna according to one embodiment of the present invention.

FIG. 2 is a plan view of the patch antenna shown in FIG. 1.

FIG. 3 is a plan view of the first modification of the patch antenna according to the present invention.

FIG. 4 is a plan view of a patch antenna according to a comparison example.

FIG. 5 is a graph showing the change of the impedance between a pair of feed points when the frequency of the signal is changed in the patch antenna according to the comparison example, and FIGS. 5(a) and (b) show the changes of the real part and the imaginary part of the impedance, respectively.

FIG. 6 is a plan view of a patch antenna according to the first example.

FIG. 7 is a graph showing the change of the impedance between a pair of feed points when the frequency of the signal is changed in the patch antenna according to the first example, and FIGS. 7(a) and (b) show the changes of the real part and the imaginary part of the impedance, respectively.

FIG. 8 is a plan view of a patch antenna according to the second example.

FIG. 9 is a graph showing the change of the impedance between a pair of feed points when the frequency of the signal is changed in the patch antenna according to the second example, and FIGS. 9(a) and (b) show the changes of the real part and the imaginary part of the impedance, respectively.

FIG. 10 is a plan view of a patch antenna according to the third example.

FIG. 11 is a graph showing the change of the impedance between a pair of feed points when the frequency of the signal is changed in the patch antenna according to the third example, and FIGS. 11(a) and (b) show the changes of the real part and the imaginary part of the impedance, respectively.

FIG. 12 is a plan view of the second modification of the patch antenna according to the present invention.

FIG. 13 is a plan view of the third modification of the patch antenna according to the present invention.

FIG. 14(a) is a plan view of a fourth modification of the patch antenna according to the present invention, and FIG. 14(b) is a cross section taken along the line XIV-XIV in FIG. 14 (a).

### DETAILED DESCRIPTION OF THE INVENTION

Hereinafter, a preferred embodiment of a patch antenna according to the present invention will be described, with reference to the attached drawings.

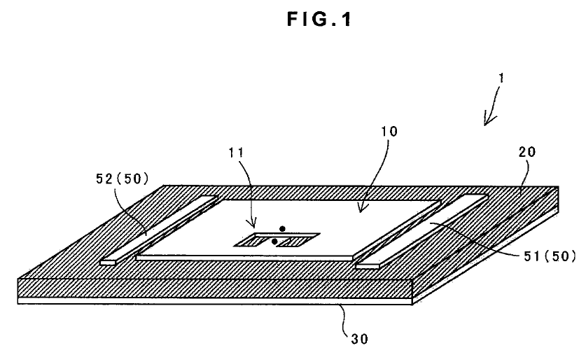

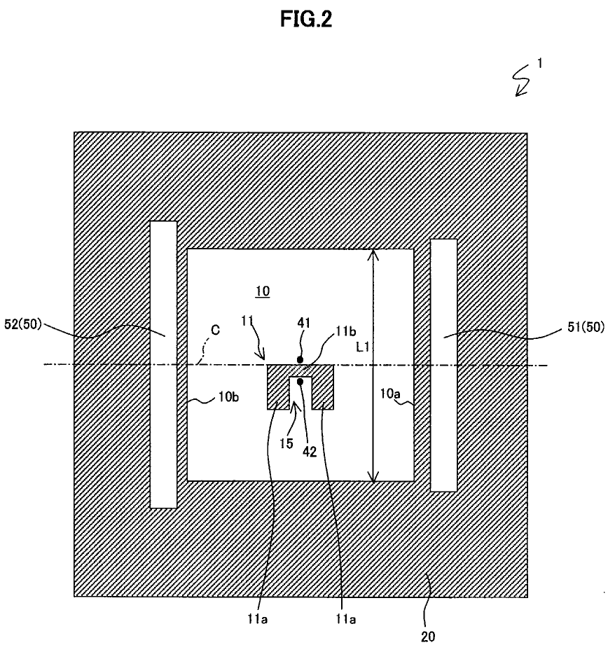

FIG. 1 and FIG. 2 are a perspective view and a plan view of the patch antenna 1 according to the present embodiment.

The patch antenna 1 forms an RFID inlet for transmitting and receiving signals to and from the outside thereof, in cooperation with a transmission/reception element (not illustrated) such as an IC chip, which is electrically connected to the patch antenna 1.

More specifically, the patch antenna 1 includes a dielectric member 20, a conductive flat-plate-shaped first radiation element 10 provided on one surface of the dielectric member 20, and a conductive flat-plate-shaped ground electrode 30 provided on the other surface of the dielectric member 20 such that it faces to the first radiation element 10 with the dielectric member 20 sandwiched therebetween.

The first radiation element 10 and the ground electrode 30 may be made of conductive materials (preferably, metals), such as Al or Cu.

The dielectric material 20 may be made of an insulation material such as FR-4 (having a relative permittivity (or dielectric constant) ∈r of 4.2 to 4.8) with a thickness of 0.1 mm to 10 mm.

The transmission/reception element has a pair of first and second connection terminals. The first connection terminal is connected to a member having a ground voltage or a member having a voltage deemed to be the ground voltage, while the second connection terminal is connected to the first radiation element 10 through a matching circuit interposed between the second connection terminal and the first radiation element 10.

In the present embodiment, the matching circuit is formed in the first radiation element 10.

More specifically, the first radiation element 10 is provided with an opening 11 which exposes a part of the dielectric member 20.

As illustrated in FIG. 2, the opening 11 includes a pair of first slits 11a extending in the direction of resonance of the first radiation element 10 so as to face to each other, and the second slit 11b communicating between the pair of first slits 11a.

This opening 11 is configured so that an area (hereinafter, referred to as a matching area 15) of the first radiation element 10 which is surrounded by the portion of the dielectric member 20 exposed through the opening 11 has the first end portion close to a portion (hereinafter, referred to as a low-voltage portion) of the first radiation member 10 which has a low voltage with respect to high-frequency voltage.

The opening 11 is sized such that the matching area 15 functions as the matching circuit.

In the present embodiment, the second slit 11b is placed at one end portion of the pair of first slits 11a.

In the configuration, the matching area 15 is formed by the area sandwiched by the pair of first slits 11a over the region between the other end portions of the pair of first slits 11a and the second slit 11b.

The low-voltage portion can be defined, for example, as a portion having the voltage V according to the following condition, wherein “Vmax” and “Vmin” are the maximum and minimum values with respect to the high-frequency voltage which the first radiation element 10 has.

Vmin≦V≦Vmin+(Vmax−Vmin)×α(0<α<1)

The α is determined according to the required performance of the RFID inlet, and is preferably set to 0.2 and, more preferably, to 0.1.

The low-voltage portion can be defined according to the following condition, instead of the aforementioned condition.

Namely, in a case where the first radiation element 10 has first and second side edges 10a and 10b with a length of L1 along the direction of resonance as in the present embodiment, the low-voltage portion can be deemed to be a portion within the range of −0.2□L1 to +0.2□L1 or, more preferably, within the range of −0.1□L1 to +0.1□L1, with a center line C as a reference, wherein the center line C connects between the center position of the first side edge 10a in the direction of resonance and the center position of the second side edge 10b in the direction of resonance.

In the configuration, the first and second connection terminals of the transmission/reception element are connected to the first radiation element 10, at the first feed point 41 and the second feed point 42 (see FIG. 2) which are positioned at one side and the other side across the second slit 11b.

With this configuration, the first connection terminal of the transmission/reception element is connected to the low-voltage portion of the first radiation element 10 which can be deemed to have the ground voltage and, the second connection terminal of the transmission/reception element is connected to the first radiation element 10 through the matching area 15 functioning as the matching circuit.

This configuration can effectively maintain the antenna performance while reducing the size of the entire patch antenna as much as possible, in comparison with a structure in which the matching circuit is provided outside of the first radiation element.

Further, with the configuration, the pair of connection terminals of the transmission/reception element are connected to the first radiation element 10 within the same plane, thereby achieving simplification and efficiency in connecting work of the transmission/reception element.

Now, the resonance frequency of the patch antenna is mainly determined by the length of the patch electrode in the direction of resonance (the length L1 of the first and second side edges 10a and 10b of the first radiation element 10, in the present embodiment) and also by the permittivity (or dielectric constant) of the dielectric member.

Namely, the patch antenna is capable of transmitting and receiving signals within only a single frequency band which is mainly determined by the length of the patch electrode in the direction of resonance and by the permittivity of the dielectric member.

In this regard, the present inventors have conceived a novel idea as follows. That is, by placing, on one surface of the dielectric member 20, an additional conductive radiation element 50 with a length different from that of the first radiation element 10 in the direction of resonance, in a state that the additional conductive radiation element 50 is insulated from the first radiation element 10 with respect to the direct electric current while being electromagnetically coupled to the first radiation element 10, it may be possible to obtain a plurality of resonance frequencies at the patch antenna 10.

Specifically, the state where the additional radiation element 50 is insulated from the first radiation element 10 with respect to the direct electric current refers to a state where the additional radiation element 50 is not coupled to the first radiation element 10 through a conductive member (see FIG. 1 and FIG. 2).

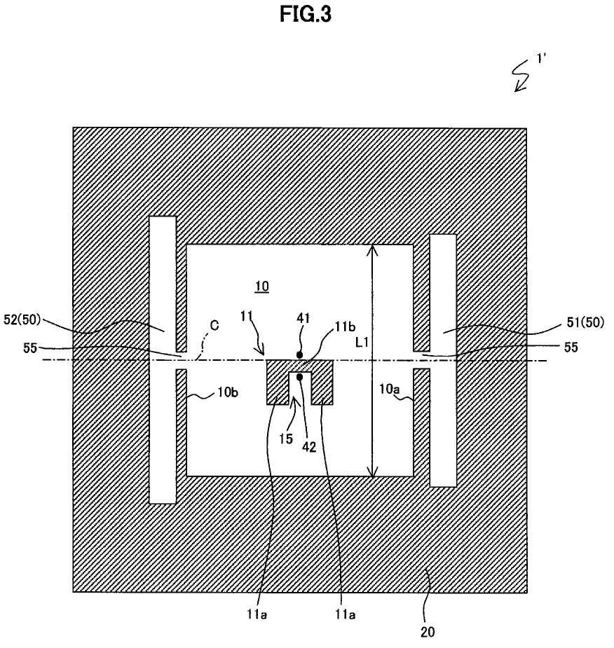

Further, a configuration where the additional radiation element 50 is connected, only at its center portion in the direction of resonance, to the center portion of the first radiation element 10 in the direction of resonance, through the conductive member 55 with a width (in the direction of resonance of the first radiation element 10) smaller than the signal wavelength, such as a width equal to or less than 1/10 of the wavelength, as illustrated in FIG. 3, could be considered as a state equivalent to the state where the additional radiation element 50 is insulated from the first radiation element 10 with respect to the direct electric current.

Specifically, even if the additional radiation element 50 is physically coupled to the first radiation element 10 through the conductive member, in the case where the conductive member 55 couples between the center portion of the additional radiation element 50 in the direction of resonance and the center portion of the first radiation element 10 in the direction of resonance, as illustrated in FIG. 3, substantially no electric current flows through the conductive member 55, which realizes a state equivalent to the state where the additional radiation element 50 is insulated from the first radiation element 10 with respect to the direct electric current.

Meanwhile, in the patch antenna 1′ configured such that the conductive member 55 couples between the center portion of the additional radiation element 50 in the direction of resonance and the center portion of the first radiation element 10 in the direction of resonance, if the conductive member 55 have a length component along the direction of resonance of the first radiation element 10, the conductive member 55 may exert an influence on the resonance characteristic. Accordingly, the conductive member 55 is placed such that both of the first end portion coupled to the first radiation element 10 and the second end portion coupled to the additional radiation element 50 are positioned within a range equal to or less than 1/10 of the signal wavelength in the direction of resonance of the first radiation element 10 with the center portion of the first radiation element 10 in the direction of resonance as a reference. Preferably, the conductive member 55 is placed such that the first and second end portions are positioned at the same position in the direction of resonance of the first radiation element 10 (namely, such that the conductive member 55 has a longitudinal direction orthogonal to the direction of resonance of the first radiation element 10).

Further, the state where the additional radiation element 50 is electromagnetically coupled to the first radiation element 10 refers to a state where there is a capacitance between the additional radiation element 50 and the first radiation element 10 and/or a state where magnetic fluxes created by the first radiation element 10 cause an induced current in the additional radiation element 50.

More specifically, the additional radiation element 50 is placed apart from the first radiation element 10, such that the distance between the additional radiation element 50 and the first radiation element 10 is equal to or less than ¼ of the wavelength of the resonance frequency of the first radiation element 10, for example, the distance is equal to or less than 1 mm to 5 mm.

The present inventors conducted the following analyses on the basis of the finite element method, regarding an example and a comparison example as follows, in order to determine whether the aforementioned idea was correct or incorrect.

Hereinafter, the example and comparison example will be described.

### COMPARISON EXAMPLE

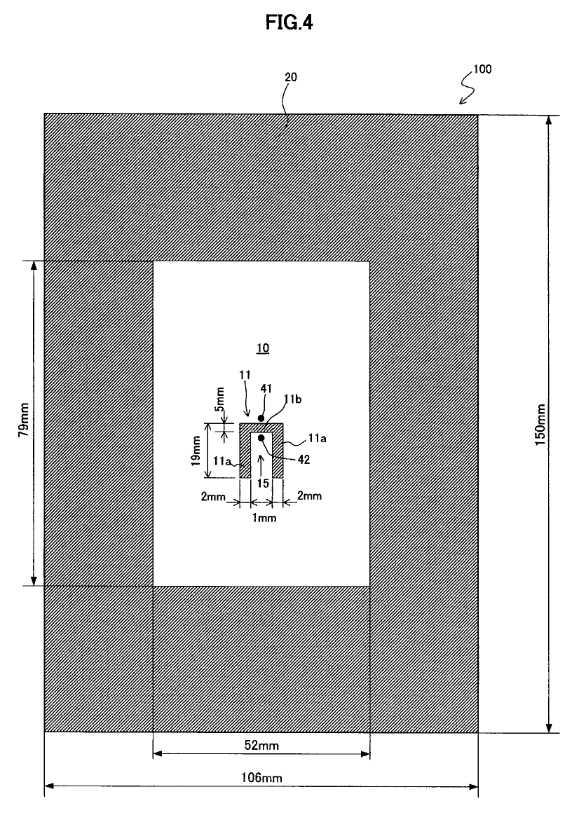

FIG. 4 illustrates a plan view of a patch antenna 100 according to the comparison example.

As illustrated in FIG. 4, the patch antenna 100 according to the comparison example includes the dielectric member 20, the first radiation element 10 placed on one surface of the dielectric member 20 and the ground electrode (not illustrated in FIG. 4) provided on the other surface of the dielectric member 20.

In the present comparison example, the dielectric member 20 is formed to have a thickness of 3.2 mm and a relative permittivity of 4.5. Further, the first radiation element 10 and the ground electrode 30 are made of aluminum with a thickness of 20 micrometers.

The other sizes of the patch antenna 100 are as illustrated in FIG. 4.

Regarding the patch antenna 100, analyses were conducted for the change of the impedance between the first feed point 41 and the second feed point 42 when the frequency of the signal was changed, on the basis of the finite element method.

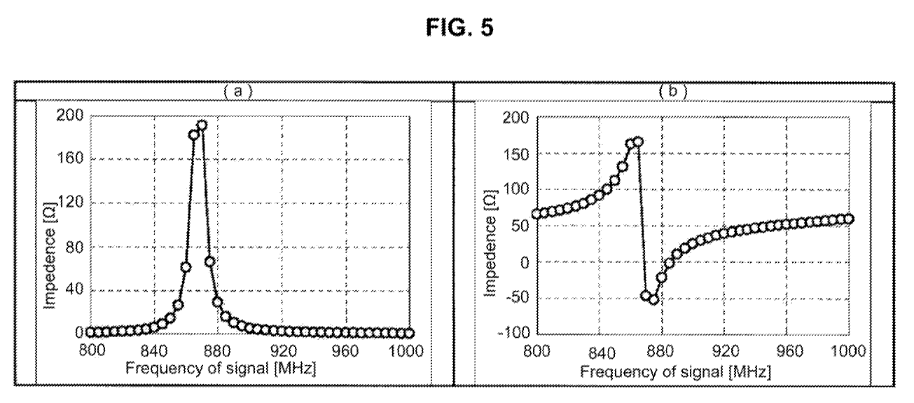

FIG. 5 illustrates the results of analyses. FIGS. 5(a) and (b) illustrate the changes of the real part and the imaginary part of the aforementioned impedance, respectively.

As is apparent from FIG. 5, only a single resonance frequency is observed around 870 MHz, in the patch antenna 100 having no additional radiation element.

### First Example

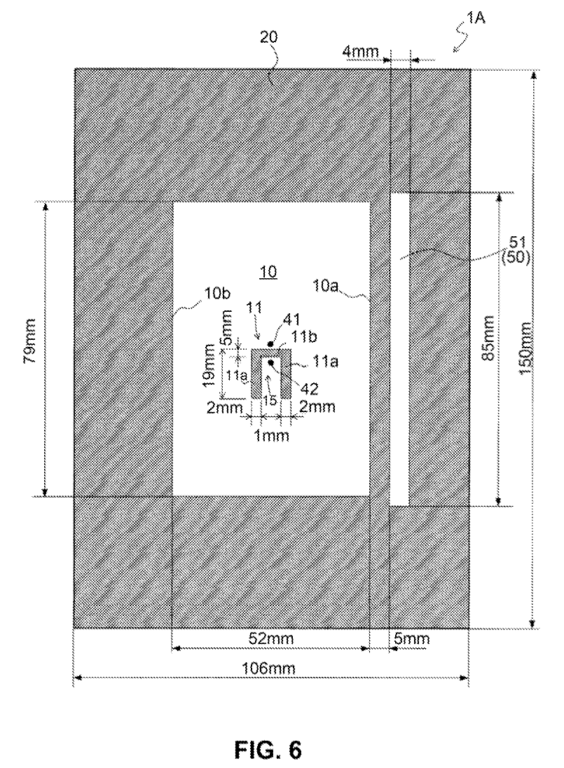

FIG. 6 illustrates a plan view of a patch antenna 1A according to the first example.

As illustrated in FIG. 6, the patch antenna 1A according to the present first example includes the dielectric member 20, the first radiation element 10, the ground electrode (not illustrated in FIG. 6), and a second radiation element 51 placed in such a way as to face to the first side edge 10a of the first radiation element 10 along the direction of resonance in a state where the second radiation element 51 is insulated from the first radiation element 10 with respect to the direct electric current while being electromagnetically coupled to the first radiation element 10.

The second radiation element 51 is formed to have a length of 85 mm in the direction of resonance, which is different from 79 mm that is the length of the first radiation element 10 in the direction of resonance. In the present first example, the second radiation element 51 is placed in parallel to the first side edge 10a at a state where the second radiation element 51 is spaced apart, by 5 mm, from the first side edge 10a.

As illustrated in FIG. 6, the patch antenna 1A according to the present first example has the same structure as that of the patch antenna 100 according to the comparison example, except that it includes the second radiation element 51.

Regarding the patch antenna 1A, the same analysis as that for the comparison example was conduced.

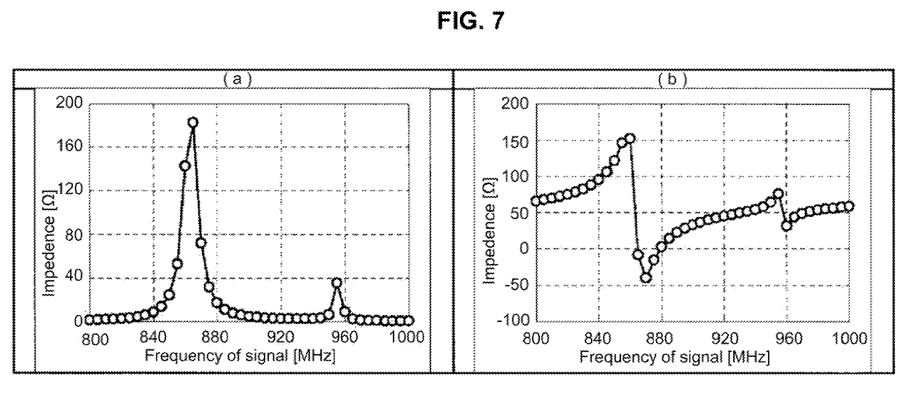

FIG. 7 illustrates the results of analyses. FIGS. 7(a) and (b) illustrate the changes of the real part and the imaginary part of the aforementioned impedance.

As is apparent from FIG. 7, two resonance frequencies are observed around 860 MHz and around 950 MHz, in the patch antenna 1A having the second radiation element 51.

### Second Example

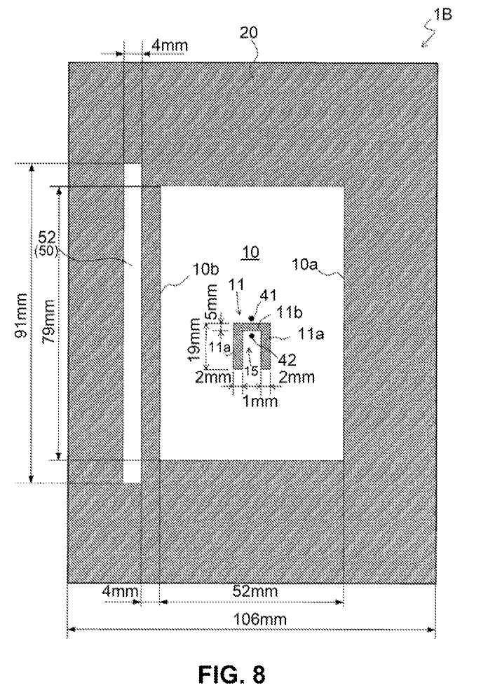

FIG. 8 illustrates a plan view of a patch antenna 1B according to the second example.

As illustrated in FIG. 8, the patch antenna 1B according to the present first example includes the dielectric member 20, the first radiation element 10, the ground electrode (not illustrated in FIG. 8), and a third radiation element 52 placed in such a way as to face to the second side edge 10b of the first radiation element 10 along the direction of resonance in a state where the third radiation element 52 is insulated from the first radiation element 10 with respect to the direct electric current while being electromagnetically coupled to the first radiation element 10.

The third radiation element 51 is formed to have a length of 91 mm in the direction of resonance, which is different from 79 mm and 85 mm that are the lengths of the first radiation element 10 and the second radiation element 51 in the direction of resonance, respectively. In the present second example, the third radiation element 52 is placed in parallel to the second side edge 10b at a state where the third radiation element 52 is spaced apart, by 4 mm, from the second side edge 10b.

The patch antenna 1B according to the present second example has the same structure as that of the patch antenna 100 according to the comparison example, except that it includes the third radiation element 52.

Regarding the patch antenna 1B, the same analysis as those for the comparison example and the first example was conduced.

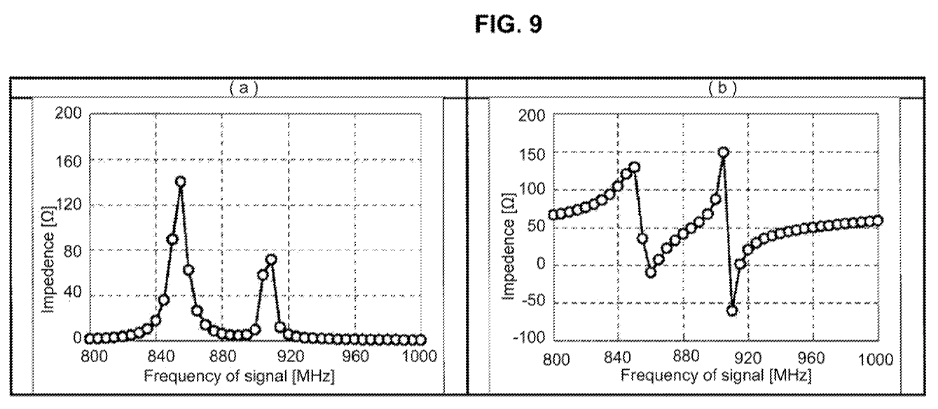

FIG. 9 illustrates the results of analyses. FIGS. 9(a) and (b) illustrate the changes of the real part and the imaginary part of the aforementioned impedance.

As is apparent from FIG. 9, two resonance frequencies are observed around 850 MHz and around 910 MHz, in the patch antenna 1B having the third radiation element 52.

### Third Example

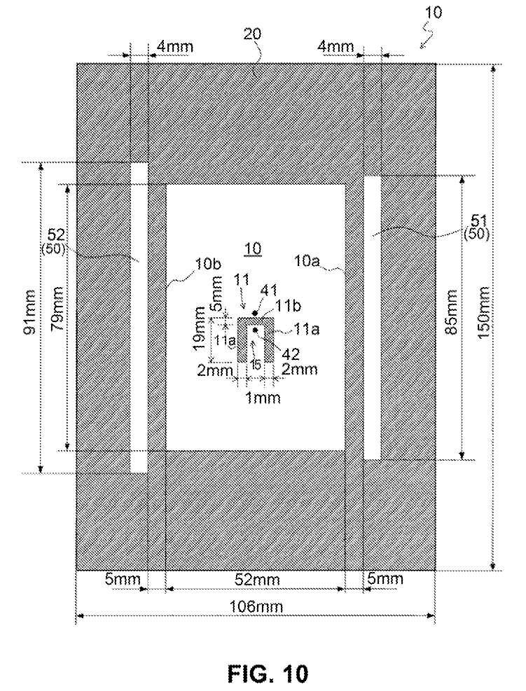

FIG. 10 illustrates a plan view of a patch antenna 1C according to the third example.

As illustrated in FIG. 10, the patch antenna 1C according to the present third example includes the dielectric member 20, the first radiation element 10, the ground electrode (not illustrated in FIG. 10), the second radiation element 51 and the third radiation element 52.

The patch antenna 1C according to the present third example has the same structure as that of the patch antenna 100 according to the comparison example, except that it includes the second and third radiation elements 51 and 52.

Regarding the patch antenna IC, the same analysis as those for the comparison example and the first and second examples was conduced.

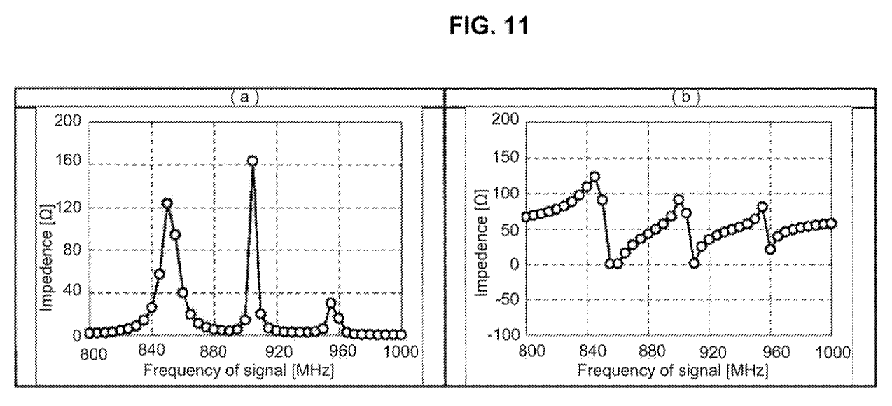

FIG. 11 illustrates the results of analyses. FIGS. 11(a) and (b) illustrate the changes of the real part and the imaginary part of the aforementioned impedance.

As is apparent from FIG. 11, three resonance frequencies are observed around 850 MHz, around 910 MHz and around 850 MHz, in the patch antenna 1C having the second and third radiation elements 51 and 52.

As is apparent from the first to third examples and the comparison example, by placing a single radiation element 50 with a length different from that of the first radiation element 10 in the direction of resonance, on one surface of the dielectric member 20, in a state where the radiation element 50 is insulated from the first radiation element 10 with respect the direct electric current while being electromagnetically coupled to the first radiation element 10, it is possible to obtain two resonance frequencies in the patch antenna 1.

Further, by placing the second radiation element 51 with a length different from that of the first radiation element 10 in the direction of resonance, on one surface of the dielectric member 20, in a state where the second radiation element 51 is insulated from the first radiation element 10 with respect the direct electric current while being electromagnetically coupled to the first radiation element 10, and also placing the third radiation element 52 with a length different from those of the first and second radiation elements 10 and 51 in the direction of resonance, on the one surface of the dielectric member 20, in a state where the third radiation element 52 is insulated from the first radiation element 10 with respect the direct electric current while being electromagnetically coupled to the first radiation element 1, it is possible to obtain three resonance frequencies in the patch antenna 1.

Furthermore, the frequency ratio among the plural resonance frequencies obtained by the provision of the radiation element 50 is close to 1.

Accordingly, by providing the second and third radiation elements 51 and 52, it is possible to cover, with the single patch antenna, the frequency ranges of 952 to 954 MHz, 902 to 928 MHz and 865 to 868 MHz which are utilized for physical distribution management in Japan, U.S. and Europe.

This may be considered for the following reasons.

Namely, in general, two conductive members with different lengths resonate at different frequencies. However, if the two conductive members are coupled to each other near their end portions in the direction of resonance, the two conductive members may have a single resonance mode as a whole. Otherwise, the patch antenna including the two conductive members coupled to each other near their end portions in the direction of resonance may have two resonance frequencies, but a frequency ratio between them shall be significantly large.

On the contrary, by providing the second radiation element 51 and/or the third radiation element 52 in a state where they are insulated with respect to the direct electric current from the first radiation element 10 which is fed with electric power while being electromagnetically coupled to the first radiation element 10 as in the present embodiment, namely by placing the second radiation element 51 and/or the third radiation element 52 so that they are in a loose coupling manner with respect to the first radiation element 10, it is possible to utilize effectively the respective resonance characteristics of the first to third radiation elements 10, 51 and 52, thereby realizing plural resonance characteristics arranged so that the frequency ratios thereamong are close to 1.

In this regard, the radiation element 50 is placed so as to face to the first radiation element 10 over at least ½ or preferably the entire of the length of the first radiation element 10 in the direction of resonance.

Further, while, in the present embodiment, as illustrated in FIG. 1 and FIG. 2, the third radiation element 52 is placed so as to face to the first radiation element 10 on a side of the first radiation element 10 opposite to the second radiation element 51, the present invention can takes various configurations, as long as the third radiation element 52 is insulated from the first radiation element 10 with respect to the direct electric current while being electromagnetically coupled to the first radiation element 10.

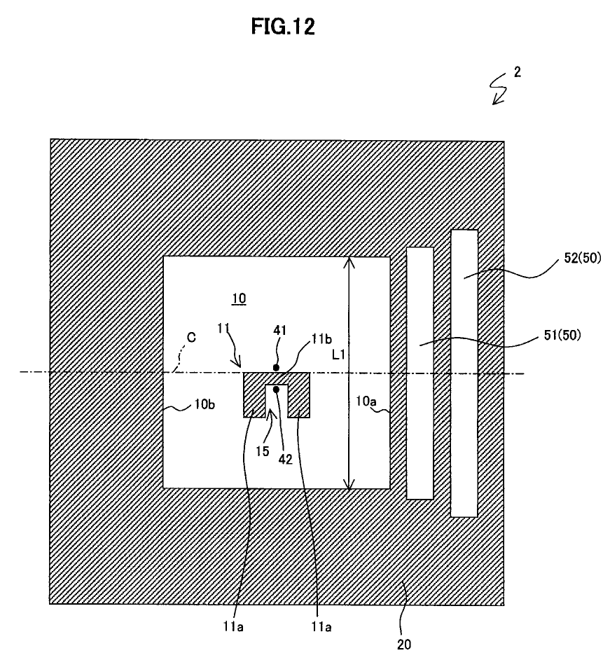

For example, as shown in FIG. 12, the third radiation element 52 can be placed so as to face to the first radiation element 10 with the second radiation element 51 sandwiched therebetween, within a range in which the third radiation element 52 is insulated from the first radiation element 10 with respect to the direct electric current while being electromagnetically coupled to the first radiation element 10.

In a patch antenna 2 where the third radiation element 52 is placed so as to face to the first radiation element 10 with the second radiation element 51 sandwiched therebetween, the third radiation element 52 is preferably formed to have an side edge which opposes to the first end side 10a of the first radiation element 10 and which is positioned substantially parallel thereto, and, more preferably, the third radiation element 52 is placed so as to face to the first side edge 10a over at least ½ of the length of the first side edge 10a.

Further, while, in the present embodiment, the present invention has been explained by taking, as an example, the patch antenna 1 configured so that the matching area 15 in the first radiation element 10 functions as the matching circuit, the present invention is not limited to this embodiment, as a matter of cause.

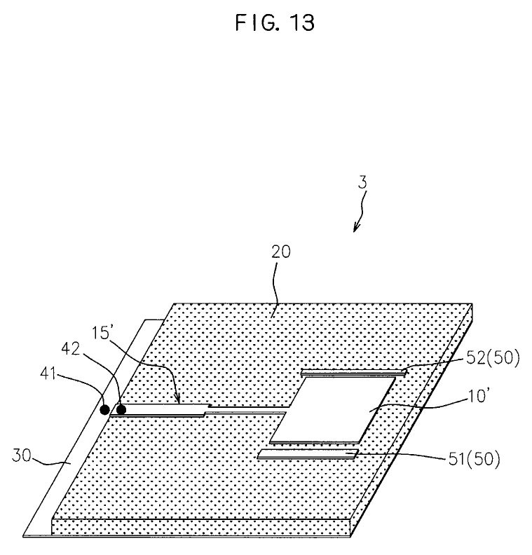

For example, as shown in FIG. 13, the second radiation element 51 and/or the third radiation element 52 can be provided in a patch antenna 3 configured so that a conductive member 15′ provided outside the first radiation element 10′ functions as the matching circuit, which can offer the same effects as those of the present embodiment.

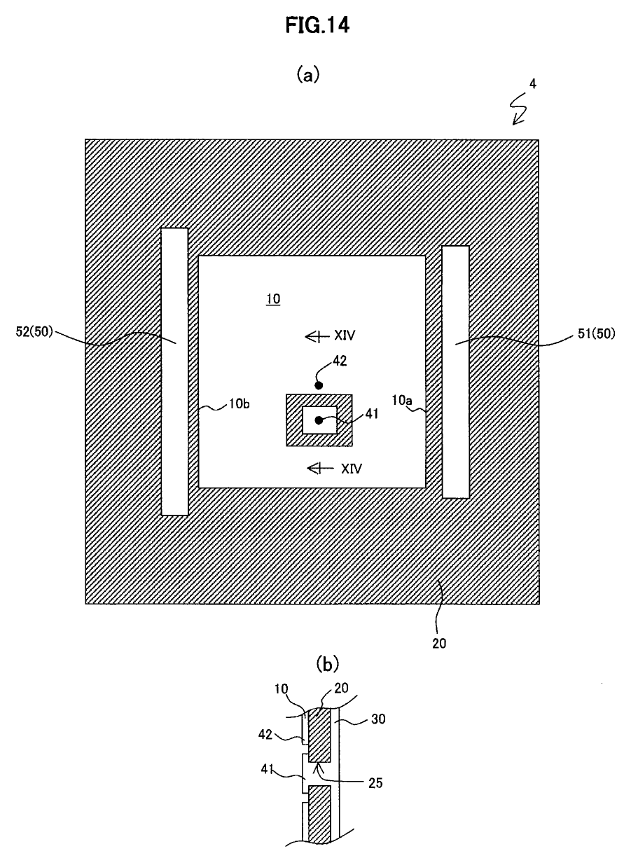

Further, as a matter of cause, as illustrated in FIG. 14, the present invention can be applied to a patch antenna 4 which is configured so as to be fed with electric power through a through hole 25 formed through the one surface and the other surface of the dielectric member 20.

This specification is by no means intended to restrict the present invention to the preferred embodiment and the modified embodiment set forth therein. Various modifications to the patch antenna and the RFID inlet may be made by those skilled in the art without departing from the spirit and scope of the present invention as defined in the appended claims.

What is claimed is:

1. A patch antenna comprising a dielectric member, and a conductive first radiation element and a conductive ground electrode respectively provided on one and the other surfaces of the dielectric member, the patch antenna further comprising;
a conductive second radiation element which has a length different from that of the first radiation element in the direction of resonance, the second radiation element being provided on the one surface of the dielectric member in a state of being insulated from the first radiation element with respect to the direct electric current while being electromagnetically coupled to the first radiation element.

2. The patch antenna according to claim 1, wherein
the first radiation element has the first side edge extending in the direction of resonance, and
the second radiation element has a side edge which is opposed to the first side edge of the first radiation element in a state of being substantially parallel to the first side edge.

3. The patch antenna according to claim 2, wherein the second radiation element is positioned so as to be opposed to the first side edge over at least ½ of the length of the first side edge.

4. The patch antenna according to claim 1, further comprising a conductive third radiation element which has a length different from those of the first and second radiation elements in the direction of resonance, the third radiation element being provided on the one surface of the dielectric member in a state of being insulated from the first radiation element with respect to the direct electric current while being electromagnetically coupled to the first radiation element.

5. The patch antenna according to claim 4, wherein the third radiation element is positioned so as to be opposed to the first radiation element on a side of the first radiation element opposite to the second radiation element with the first radiation element being sandwiched between the second and third radiation elements.

6. The patch antenna according to claim 5, wherein
the first radiation element has the second side edge extending in the direction of resonance on a side opposite to the first side edge, and
the third radiation element has a side edge which is opposed to the second side edge of the first radiation element in a state of being substantially parallel to the second side edge.

7. The patch antenna according to claim 6, wherein the third radiation element is positioned so as to be opposed to the second side edge over at least ½ of the length of the second side edge.

8. The patch antenna according to claim 4, wherein the third radiation element is positioned so as to be opposed to the first radiation element in a state that the second radiation element is sandwiched by the first and third radiation elements.

9. The patch antenna according to claim 8, wherein the third radiation element has a side edge which is opposed to the first side edge of the first radiation element in a state of being substantially parallel to the first side edge.

10. The patch antenna according to claim 9, wherein the third radiation element is positioned so as to be opposed to the first side edge over at least ½ of the length of the first side edge.

11. A patch antenna comprising a dielectric member, and a conductive first radiation element and a conductive ground electrode respectively provided on one and the other surfaces of the dielectric member, the patch antenna further comprising;
a conductive second radiation element which has a length different from that of the first radiation element in the direction of resonance and which is provided on the one surface of the dielectric member, wherein
the second radiation element is configured so that only its center portion in the direction of resonance is connected to the center portion of the first radiation element in the direction of resonance through a conductive member having a width smaller than the signal wavelength and the other portion of the second radiation element is positioned away from the first radiation element within a range of being electromagnetically coupled to the first radiation element.

12. An RFID inlet comprising the patch antenna according to claim 1, and a transmission/reception element transmitting and receiving signals through the patch antenna.

13. An RFID inlet comprising the patch antenna according to claim 11, and a transmission/reception element transmitting and receiving signals through the patch antenna.
